(19) United States
(12) Patent Application Publication
(10) Pub. No.: US 2021/0280134 A1
(43) Pub. Date: Sep. 9, 2021

(54) PIXEL DRIVING CIRCUIT

(71) Applicant: Shenzhen China Star Optoelectronics Semiconductor Display Technology Co., Ltd., Shenzhen Guangdong (CN)

(72) Inventors: Suixin ZHAO, Shenzhen Guangdong (CN); Baixiang HAN, Shenzhen Guangdong (CN)

(73) Assignee: Shenzhen China Star Optoelectronics Semiconductor Display Technology Co., Ltd., Shenzhen Guangdong (CN)

(21) Appl. No.: 16/624,917

(22) PCT Filed: Oct. 24, 2019
(86) PCT No.: PCT/CN2019/113028

§ 371 Date: Dec. 20, 2019

(30) Foreign Application Priority Data
Sep. 17, 2019 (CN) 201910878206.7

(51) Int. Cl. G09G 3/3258

(52) U.S. Cl. CPC G09G 3/3258; G09G 2300/0809

(57) ABSTRACT

A pixel driving circuit including a driving thin-film transistor; a regulating capacitor, wherein a first terminal of the regulating capacitor is connected to a control terminal of the driving thin-film transistor, and a second terminal of the regulating capacitor is connected to a first terminal of the driving thin-film transistor; a first capacitor, wherein a first terminal of the first capacitor is connected to the control terminal of the driving thin-film transistor, and a second terminal of the first capacitor is connected to a second terminal of the driving thin-film transistor; and a light-emitting device, wherein a first terminal of the light-emitting device is connected to the second terminal of the driving thin-film transistor, and a second terminal of the light-emitting device is grounded.

### FIELD OF INVENTION

The present invention relates to the technical field of display, and especially to a pixel driving circuit.

### BACKGROUND OF INVENTION

In comparison with liquid crystal displays (LCDs), organic light-emitting diode (OLED) display panels are self-luminous and that is a unique advantage. They also have competitive advantages such as less power consumption, high contrast, wide color gamut, foldable, etc. and have currently become the mainstream display panels.

However, after finishing charging and gate thin-film transistor turning off, rapid variation of voltage of the conventional pixel driving circuits will produce a serious feedthrough effect, which leads to decreased display uniformity of a panel, especially under the condition of low gray scaling.

### SUMMARY OF INVENTION

The present invention provides a pixel driving circuit to resolve the technical problem of decreased display panel uniformity of the conventional pixel driving circuits caused by a feedthrough effect.

In order to resolve the above-mentioned problem, the present invention provides the following technical approach.

The present invention provides a pixel driving circuit that includes a driving thin-film transistor; a regulating capacitor, wherein a first terminal of the regulating capacitor is connected to a control terminal of the driving thin-film transistor, and a second terminal of the regulating capacitor is connected to a first terminal of the driving thin-film transistor; a first capacitor, wherein a first terminal of the first capacitor is connected to the control terminal of the driving thin-film transistor, and a second terminal of the first capacitor is connected to a second terminal of the driving thin-film transistor; and a light-emitting device, wherein a first terminal of the light-emitting device is connected to the second terminal of the driving thin-film transistor, and a second terminal of the light-emitting device is grounded.

According to at least one embodiment of the present invention, the pixel driving circuit further includes a first switch, wherein a first terminal of the first switch is connected to a first signal terminal, and a second terminal of the first switch is connected to the control terminal of the driving thin-film transistor.

According to at least one embodiment of the present invention, the pixel driving circuit further includes a second switch, wherein a first terminal of the second switch is connected to the second terminal of the driving thin-film transistor, and a second terminal of the second switch is connected to a second signal terminal.

According to at least one embodiment of the present invention, the first switch and the second switch are thin-film transistors.

According to at least one embodiment of the present invention, the driving thin-film transistor, the first switch, and the second switch are negative channel metal-oxide-semiconductor field-effect transistors (MOSFETs).

According to at least one embodiment of the present invention, the first switch is a gate thin-film transistor.

According to at least one embodiment of the present invention, the second switch is a sensing thin-film transistor.

According to at least one embodiment of the present invention, the light-emitting device is an organic light emitting diode.

According to at least one embodiment of the present invention, the first signal terminal is a data signal terminal.

According to at least one embodiment of the present invention, the first capacitor is a storing capacitor.

The pixel driving circuit according to the present invention, a regulating capacitor is added at a gate of the driving thin-film transistor, and one terminal of the regulating capacitor is connected to high voltage level VDD to regulate voltage. Voltage loss caused by a feedthrough effect when the first switch is turned off can be decreased such that Vgs of driving thin-film transistors at different positions in a panel can be approximately identical, difference of current passing through the light-emitting device is decreased, and display uniformity of a panel is increased.

### DESCRIPTION OF DRAWINGS

In order to further understand features and technical contents of the present invention, please refer to the following detailed description and accompanying drawings of the present invention. However, the accompanying drawings are used for purpose of explanation and do not limit the present invention.

With reference to the following drawings, the technical approach and other beneficial effects of the present invention will be obvious through describing embodiments of the present invention in detail.

The drawings are as the following.

FIG. 1 is a circuit diagram of a pixel driving circuit according to an embodiment of the present invention.

### DETAILED DESCRIPTION OF PREFERRED EMBODIMENTS

In order to further describe the technical approach and the effects of the present invention, the following describes in detail with reference to advantageous embodiments and the accompanying drawings of the present invention.

The present invention directs to the technical problem of decreased display panel uniformity of the conventional pixel driving circuits caused by feedthrough effect, and the present embodiment can resolve this drawback.

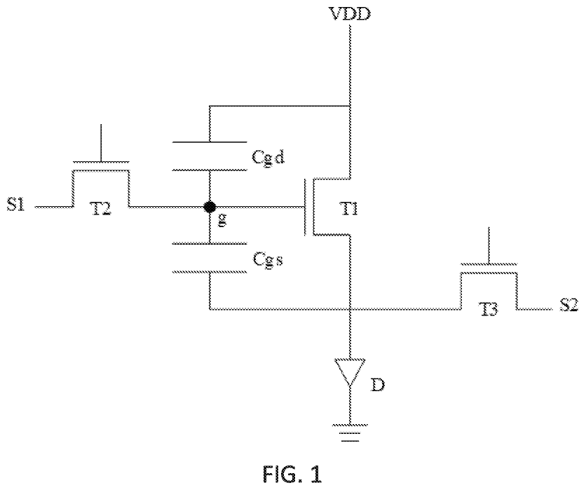

FIG. 1 is a circuit diagram of a pixel driving circuit according to an embodiment of the present invention. The pixel driving circuit includes a driving thin-film transistor T1; a regulating capacitor Cgd, wherein a first terminal of the regulating capacitor is connected to a control terminal of the driving thin-film transistor T1, and a second terminal of the regulating capacitor Cgd is connected to a first terminal of the driving thin-film transistor T1; a first capacitor Cgs, wherein a first terminal of the first capacitor Cgs is connected to the control terminal of the driving thin-film transistor T1, and a second terminal of the first capacitor Cgs is connected to a second terminal of the driving thin-film transistor T1; and a light-emitting device D, wherein a first terminal of the light-emitting device D is connected to the second terminal of the driving thin-film transistor T1, and a second terminal of the light-emitting device D is grounded. The first capacitor Cgs is a storing capacitor. The pixel driving circuit further includes a first switch T2, wherein a first terminal of the first switch T2 is connected to a first signal terminal S1, and a second terminal of the first switch T2 is connected to the control terminal of the driving thin-film transistor T1. The first switch T2 is a gate thin-film transistor. The first signal terminal S1 is a data signal terminal. The pixel driving circuit further includes a second switch T3, wherein a first terminal of the second switch T3 is connected to the second terminal of the driving thin-film transistor T1, and a second terminal of the second switch T3 is connected to a second signal terminal S2. The second switch T3 is a sensing thin-film transistor. The driving thin-film transistor T1, the first switch T2, and the second switch T3 are negative channel metal-oxide-semiconductor field-effect transistors (MOSFETs). The light-emitting device D is an organic light emitting diode (OLED).

Because RC time constants at different positions of a panel are different, in the conventional pixel driving circuit, various degrees of a feedthrough effect will occur when the first switch T2 is turned off, which leads to different voltage values of the g point corresponding to different pixels during an illuminating course, and different Vgs values of driving thin-film transistors T1 at different positions of a panel; therefore current passing through the light-emitting device D (such as an OLED) is different in value, which eventually results in worse display uniformity of a panel.

As shown in FIG. 1, the pixel driving circuit according to an embodiment of the present invention adds a regulating capacitor Cgd at a gate of the driving thin-film transistor T1, and connects one terminal of the regulating capacitor Cgd to high voltage level VDD to regulate voltage. Voltage loss of the g point caused by a feedthrough effect when the first switch T2 is turned off can be decreased such that Vgs of driving thin-film transistors T1 at different positions in a panel can be approximately identical, difference of current passing through the light-emitting device D is decreased, and display uniformity of a panel is increased.

Table 1 are data of display nonuniformity of the conventional pixel driving circuit under the condition of high gray scaling and low gray scaling. Under the condition of low gray scaling, because voltage is lower, the pixel driving circuit is more obviously affected by a feedthrough effect, nonuniformity reaches as high as 76.13%, and difference of nonuniformity under different gray scaling condition is also greater.

TABLE 1

| | nonuniformity | Max Vg_FT |
|---|---|---|
| High gray scaling | 10.26% | 0.578 V |
| Low gray scaling | 76.13% | 0.804 V |

Table 2 are data of display nonuniformity of the pixel driving circuit according to an embodiment of the present invention under the condition of high gray scaling and low gray scaling. Because maintaining effect of the regulating capacitor Cgd to voltage of the g point, the pixel driving circuit is less affected by a feedthrough effect, display uniformity under the condition of high gray scaling and low gray scaling is both significantly increased, and difference of nonuniformity under different gray scaling condition is also decreased. Wherein, Max Vg_FT is a difference value between charged voltage of the g point and the value when voltage of the g point drops to the lowest after the first switch T2 is turned off, selecting the greatest of the difference values at different positions in a panel.

TABLE 2

| | nonuniformity | Max Vg_FT | |
|---|---|---|---|
| High gray scaling | 3.6% | 0.28 | V |
| Low gray scaling | 24.82% | 0.356 | V |

Beneficial effects: the pixel driving circuit according to the present invention, a regulating capacitor Cgd is added at a gate of the driving thin-film transistor T1, and one terminal of the regulating capacitor Cgd is connected to high voltage level VDD to regulate voltage. Voltage loss caused by a feedthrough effect to the g point when the first switch T2 is turned off can be decreased such that Vgs of driving thin-film transistors T1 at different positions in a panel can be approximately identical, difference of current passing through the light-emitting device D is decreased, and display uniformity of a panel is increased.

Although the present invention has been explained in relation to its preferred embodiment, it does not intend to limit the present invention. It will be apparent to those skilled in the art having regard to this present invention that other modifications of the exemplary embodiments beyond these embodiments specifically described here may be made without departing from the spirit of the invention. Accordingly, such modifications are considered within the scope of the invention as limited solely by the appended claims.

What is claimed is:

1. A pixel driving circuit, comprising:
a driving thin-film transistor;
a regulating capacitor, wherein a first terminal of the regulating capacitor is connected to a control terminal of the driving thin-film transistor, and a second terminal of the regulating capacitor is connected to a first terminal of the driving thin-film transistor;
a first capacitor, wherein a first terminal of the first capacitor is connected to the control terminal of the driving thin-film transistor, and a second terminal of the first capacitor is connected to a second terminal of the driving thin-film transistor; and
a light-emitting device, wherein a first terminal of the light-emitting device is connected to the second terminal of the driving thin-film transistor, and a second terminal of the light-emitting device is grounded.

2. The pixel driving circuit as claimed in claim 1, comprising a first switch, wherein a first terminal of the first switch is connected to a first signal terminal, and a second terminal of the first switch is connected to the control terminal of the driving thin-film transistor.

3. The pixel driving circuit as claimed in claim 2, comprising a second switch, wherein a first terminal of the second switch is connected to the second terminal of the driving thin-film transistor, and a second terminal of the second switch is connected to a second signal terminal.

4. The pixel driving circuit as claimed in claim 3, wherein the first switch and the second switch are thin-film transistors.

5. The pixel driving circuit as claimed in claim 4, wherein the driving thin-film transistor, the first switch, and the second switch are negative channel metal-oxide-semiconductor field-effect transistors (MOSFETs).

6. The pixel driving circuit as claimed in claim 4, wherein the first switch is a gate thin-film transistor.

7. The pixel driving circuit as claimed in claim 4, wherein the second switch is a sensing thin-film transistor.

8. The pixel driving circuit as claimed in claim 5, wherein the light-emitting device is an organic light emitting diode.

9. The pixel driving circuit as claimed in claim 2, wherein the first signal terminal is a data signal terminal.

10. The pixel driving circuit as claimed in claim 1, wherein the first capacitor is a storing capacitor.

11. A pixel driving circuit, comprising:
a driving thin-film transistor;
a regulating capacitor, wherein a first terminal of the regulating capacitor is connected to a control terminal of the driving thin-film transistor, and a second terminal of the regulating capacitor is connected to a first terminal of the driving thin-film transistor;
a first capacitor, wherein a first terminal of the first capacitor is connected to the control terminal of the driving thin-film transistor, and a second terminal of the first capacitor is connected to a second terminal of the driving thin-film transistor;
a light-emitting device, wherein a first terminal of the light-emitting device is connected to the second terminal of the driving thin-film transistor, and a second terminal of the light-emitting device is grounded; and
a first switch, wherein a first terminal of the first switch is connected to a first signal terminal, and a second terminal of the first switch is connected to the control terminal of the driving thin-film transistor.

12. The pixel driving circuit as claimed in claim 11, comprising a second switch, wherein a first terminal of the second switch is connected to the second terminal of the driving thin-film transistor, and a second terminal of the second switch is connected to a second signal terminal.

13. The pixel driving circuit as claimed in claim 12, wherein the first switch and the second switch are thin-film transistors.

14. The pixel driving circuit as claimed in claim 13, wherein the driving thin-film transistor, the first switch, and the second switch are negative channel metal-oxide-semiconductor field-effect transistors (MOSFETs).

15. The pixel driving circuit as claimed in claim 13, wherein the first switch is a gate thin-film transistor.

16. The pixel driving circuit as claimed in claim 13, wherein the second switch is a sensing thin-film transistor.

17. The pixel driving circuit as claimed in claim 14, wherein the light-emitting device is an organic light emitting diode.

18. The pixel driving circuit as claimed in claim 11, wherein the first signal terminal is a data signal terminal.

19. The pixel driving circuit as claimed in claim 11, wherein the first capacitor is a storing capacitor.
